(19) United States
(12) Patent Application Publication
(10) Pub. No.: US 2026/0217217 A1
(43) Pub. Date: Jul. 30, 2026

(54) VEHICLE CONTROL DEVICE

(71) Applicant: TOYOTA JIDOSHA KABUSHIKI KAISHA, Toyota-shi (JP)

(72) Inventors: Ryosuke TANIMURA, Nagoya-shi (JP); Aika MIYAJIMA, Nagoya-shi (JP); Akari YAMADA, Nagoya-shi (JP); Reina YAMAMURA, Nagoya-shi (JP)

(73) Assignee: TOYOTA JIDOSHA KABUSHIKI KAISHA, Toyota-shi (JP)

(21) Appl. No.: 19/434,164

(22) Filed: Dec. 29, 2025

(30) Foreign Application Priority Data
Jan. 28, 2025 (JP) 2025-012420

(51) Int. Cl. B60R 25/045; B60R 25/25; B60R 25/30; G07B 15/02; B60R 25/04

(52) U.S. Cl. CPC B60R 25/045; B60R 25/25; B60R 25/305; G07B 15/02; B60R 2025/0405

(57) ABSTRACT

A vehicle control device includes a processor. The processor disables engine start of an object vehicle in response to receiving a first signal that indicates that payment of a debt for the object vehicle has not been properly performed, acquires use purpose information, and determines whether the object vehicle is used for an intended purpose. The processor cancels the disability of the engine start of the object vehicle when the processor determines that the object vehicle is used for the intended purpose, and acquires use situation information. Furthermore, the processor determines whether the object vehicle is used for an unintended purpose, based on the use situation information and the use purpose information, and disables the engine start of the object vehicle again, when the processor determines that the object vehicle is used for the unintended purpose.

### CROSS-REFERENCE TO RELATED APPLICATION

This application claims priority to Japanese Patent Application No. 2025-012420 filed on January 28, 2025. The disclosure of the above-identified application, including the specification, drawings, and claims, is incorporated by reference herein in its entirety.

### BACKGROUND

### 1. Technical Field

The present disclosure relates to a vehicle control device.

### 2. Description of Related Art

Japanese Patent No. 6647509 (JP 6647509 B) discloses a technology in which an individual or juristic person other than a user of a vehicle, for example, an owner (hereinafter referred to as merely "creditor") of the vehicle performs the engine start disability of the vehicle for credit protection or for a safety reason. In this technology, the creditor disables engine start when the credit cannot be collected from a debtor such as the user, and cancels the disability of the engine start when the credit can be collected from the debtor.

Meanwhile, after the engine start disability of the vehicle is activated, the creditor sometimes cancels the engine start disability of the vehicle, for permitting the use of the vehicle, in the case where the debtor must use the vehicle for daily life, for example, for going to work or going to hospital. For example, when the creditor does not allow a minimal use in the daily life of the debtor, obligation fulfillment by the debtor is further delayed, resulting in a disadvantage.

### SUMMARY

However, when the engine start disability is unconditionally cancelled, it is difficult to perform the protection of the credit and it is not possible to achieve the credit collection that is creditor's purpose. Therefore, there is room for improvement.

The present disclosure has been made in view of the above description, and provides a vehicle control device that makes it possible to perform the protection of the credit, to achieve the credit collection, and to flexibly use the vehicle.

A vehicle control device according to the present disclosure includes a processor. The processor is configured to: perform a control to disable engine start of an object vehicle when a first signal is received from a credit management server configured to manage a credit for the object vehicle, the first signal indicating that payment of a debt for the object vehicle has not been properly performed; acquire use purpose information relevant to a purpose of use of the object vehicle; determine whether the object vehicle is used for an intended purpose, based on the use purpose information; perform a control to cancel the disability of the engine start of the object vehicle, when the processor determines that the object vehicle is used for the intended purpose; acquire use situation information relevant to a situation of use of the object vehicle; determine whether the object vehicle is used for an unintended purpose, based on the use situation information and the use purpose information; and perform a control to disable the engine start of the object vehicle again, when the processor determines that the object vehicle is used for the unintended purpose.

A vehicle control device according to the present disclosure includes a processor. The processor is configured to: disable engine start of an object vehicle in response to receiving a first signal, the first signal indicating that payment of a debt for the object vehicle has not been properly performed; acquire use purpose information relevant to a purpose of use of the object vehicle; determine whether the object vehicle is used for an intended purpose, based on the use purpose information; cancel the disability of the engine start of the object vehicle when the processor determines that the object vehicle is used for the intended purpose; acquire use situation information relevant to a situation of use of the object vehicle; determine whether the object vehicle is used for an unintended purpose, based on the use situation information and the use purpose information; and disable the engine start of the object vehicle again, when the processor determines that the object vehicle is used for the unintended purpose.

With the present disclosure, it is possible to perform the protection of the credit, to achieve creditor's purpose, and to permit the use of the vehicle.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 is a block diagram showing a schematic configuration of a vehicle control system according to an embodiment 1 of the present disclosure;

FIG. 2 is a sequence diagram showing an example of exchange of information among a credit collection server, a vehicle information server, and a vehicle that are included in the vehicle control system according to the embodiment 1 of the present disclosure;

FIG. 3 is a flowchart showing an outline of a process that is executed by the credit collection server according to the embodiment 1 of the present disclosure;

FIG. 4 is a flowchart showing an outline of a process that is executed by the vehicle information server according to the embodiment 1 of the present disclosure when the engine start disability of the vehicle is cancelled after the engine start is disabled;

FIG. 5 is a flowchart showing an outline of a process that is executed by the vehicle information server according to the embodiment 1 of the present disclosure when the engine start disability of the vehicle is activated;

FIG. 6 is a flowchart showing an outline of a process that is executed by the vehicle according to the embodiment 1 of the present disclosure when the engine start disability is cancelled after the engine start is disabled;

FIG. 7 is a flowchart showing an outline of a process that is executed by the vehicle according to the embodiment 1 of the present disclosure when the engine start is disabled again after the engine start disability is cancelled; and

FIG. 8 is a flowchart showing an outline of a process that is executed by a vehicle according to an embodiment 2 of the present disclosure.

### DETAILED DESCRIPTION OF EMBODIMENTS

Vehicle control devices according to embodiments of the present disclosure will be described below with reference to the drawings. Each constituent element in the following embodiments includes constituent elements that can easily substituted by a person skinned in the art, or substantially identical substituent elements.

### Embodiment 1

### Vehicle Control System

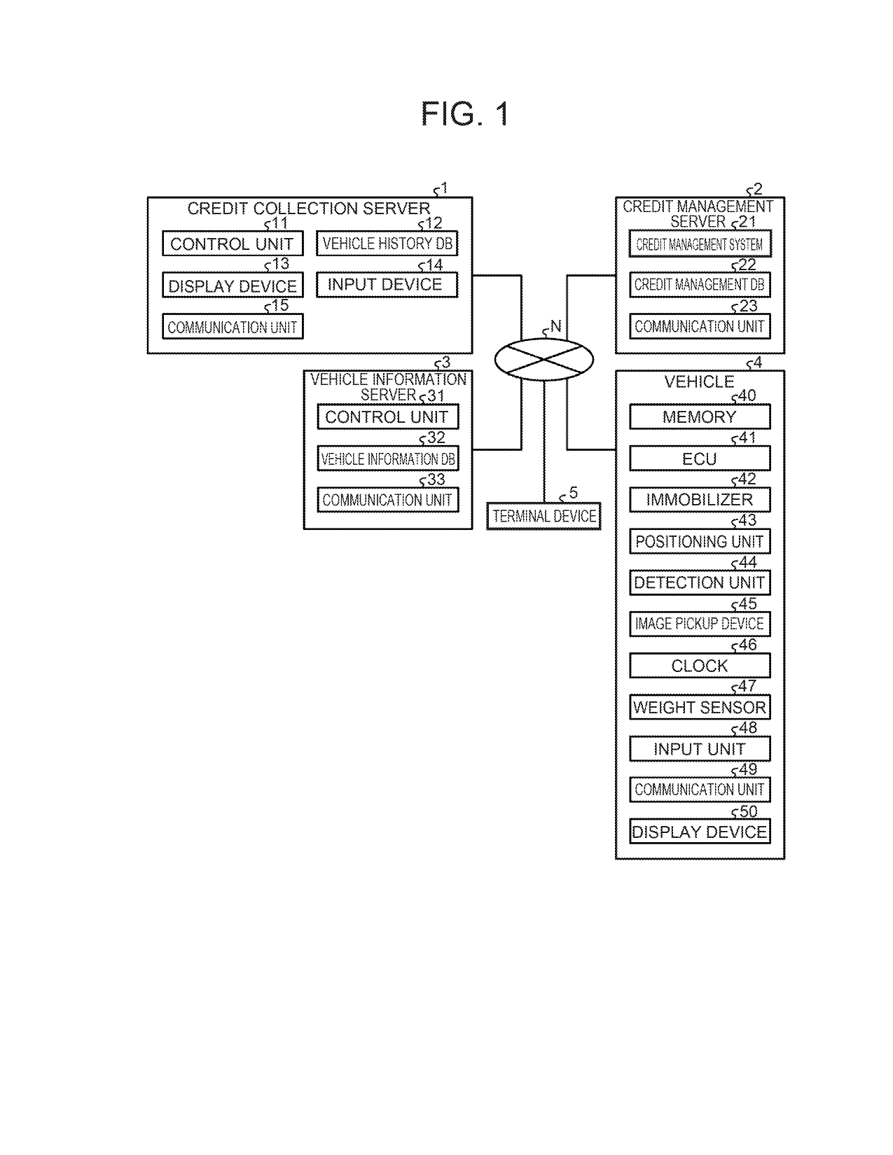

FIG. 1 is a block diagram showing a schematic configuration of a vehicle control system according to an embodiment 1. A vehicle control system 100 shown in FIG. 1 includes a credit collection server 1, a credit management server 2, a vehicle information server 3, a vehicle 4, and a terminal device 5. The credit collection server 1, the credit management server 2, the vehicle information server 3, the vehicle 4, and the terminal device 5 each have a communication function, and are configured to be capable of communicating with each other through a network N and exchanging a variety of information. For example, the network N is constituted by a public line network such as the internet and a cellular line network. Further, the credit collection server 1 of the vehicle control system according to the embodiment 1 functions as a vehicle control device that remotely controls the operation (particularly, engine start disability by an immobilizer and cancellation of the engine start disability) of the vehicle 4.

In the embodiment 1, examples of the "credit" include a credit relevant to installment contract at the time of vehicle purchase, a credit relevant to lease contract for the vehicle 4, a credit relevant to subscription contract for the vehicle 4, and a credit relevant to rental contract for the vehicle 4.

For example, a creditor in the embodiment 1 is an owner (processor) of the vehicle 4. Specifically, examples of the creditor include a dealer that sells the vehicle 4, a credit company, and a bank. For example, a debtor in the embodiment 1 is a user of the vehicle 4. Specifically, examples of the debtor include a purchaser of the vehicle 4 and a contractor or business company about lease contract and the like.

### Functional Configuration of Credit Collection Server

First, the functional configuration of the credit collection server 1 will be described. The credit collection server 1 remotely controls the operation of the vehicle 4, for collecting the credit relevant to the vehicle 4. As shown in FIG. 1, the credit collection server 1 includes a control unit 11, a vehicle history database (DB) 12, a display device 13, an input device 14, and a communication unit 15.

For example, the control unit 11 is realized by a processor constituted by a central processing unit (CPU) and the like, and a memory (main storage unit) constituted by a random access memory (RAM), a read only memory (ROM), and the like. In the case where the vehicle 4 meets a previously determined requirement (hereinafter referred to as "engine start disability requirement") for the engine start disability, the control unit 11 acquires predetermined information from the vehicle history DB 12 and the vehicle information server 3, and determines whether the engine start disability is activated, based on the predetermined information. In the case where it is determined that the engine start disability is activated, the control unit 11 disables the engine start of the vehicle 4 (the engine is controlled so as not to be started).

Examples of the "engine start disability requirement" include a case where the debtor about the vehicle 4 falls into obligation non-fulfillment (for example, payment delay). The determination of whether the engine start disability requirement is met is performed by the credit collection server 1, for example. In the case where there is a vehicle 4 (object vehicle) that meets the engine start disability requirement, information (for example, vehicle identification number (VIN number)) for specifying the vehicle 4 is sent from the credit management server 2 to the credit collection server 1. For example, the object vehicle is the vehicle 4 for which there is the credit.

In the case where the control unit 11 acquires (receives) use purpose information relevant to the purpose of the use of the vehicle 4, from a predetermined terminal device, for example, from the terminal device 5 of the debtor, for the vehicle 4 in which the engine start is disabled, the control unit 11 determines whether the vehicle 4 is used for an intended purpose, based on the use purpose information. Then, in the case where the control unit 11 determines that the vehicle 4 is used for the intended purpose, the control unit 11 cancels the disability of the engine start of the vehicle 4 by remote control. After the disability of the engine start of the vehicle 4 is cancelled, the control unit 11 acquires use situation information relevant to the situation of the use of the vehicle 4, and determines whether the vehicle 4 is used for an unintended purpose, based on the acquired use situation information and the use purpose information given from the terminal device 5 of the debtor. Then, in the case where the control unit 11 determines that the vehicle 4 is used for the unintended purpose, the control unit 11 outputs a disabling signal for activating the engine start disability of the vehicle 4, to an immobilizer 42 of the vehicle 4, and disables the engine start of the vehicle 4 again by remote control.

The vehicle history DB 12 is a database that is constituted using a hard disk drive (HDD), a solid state drive (SSD), or the like and that stores a variety of information relevant to the vehicle 4. For example, the vehicle history DB 12 acquires the use situation information from the vehicle information server 3, and stores the use situation information in association with the vehicle identification number (VIN number). Further, the vehicle history DB 12 stores, for example, routine vehicle-stop position information that is created by the control unit 11 based on the use situation information stored in the vehicle history DB 12 and that is relevant to a position where the vehicle 4 is routinely or daily stopped or parked.

For example, the display device 13 is realized by a liquid crystal display (LCD), an organic EL display (OLED), or the like. The display device 13 displays a variety of information under the control by the control unit 11.

For example, the input device 14 is realized by a touch panel, a keyboard, a pointing device, or the like. The input device 14 accepts the input of a variety of operations by the user, and outputs signals corresponding to accepted operations, to the control unit 11.

For example, the communication unit 15 is constituted by a local area network (LAN) interface board, a wireless communication circuit for wireless communication, and the like. The communication unit 15 exchanges information with the credit management server 2 and the vehicle information server 3, by the communication through the network N, under the control by the control unit 11.

### Functional Configuration of Credit Management Server

Next, the functional configuration of the credit management server 2 will be described. The credit management server 2 manages the credit relevant to the vehicle 4. The credit management server 2 includes a credit management system 21, a credit management DB 22, and a communication unit 23.

In the case where a plurality of vehicles 4 managed by the credit management DB 22 includes a vehicle 4 (object vehicle) that meets the requirement for the engine start disability, the credit management system 21 sends information (for example, the vehicle identification number (VIN number)) for specifying the vehicle 4, to the credit collection server 1. The vehicle 4 (object vehicle) that meets the engine start disability requirement is a vehicle 4 (object vehicle) for which the payment for the credit by the debtor has been delayed, a vehicle 4 (object vehicle) for which the payment of the debt has not been properly performed, or a vehicle 4 for which obligation non-fulfillment has occurred.

The credit management DB 22 associates and manages information for specifying each vehicle 4 and information relevant to the credit for the vehicle 4. For example, the information for specifying each vehicle 4 is the vehicle identification number (VIN number). For example, the information relevant to the credit for the vehicle 4 is repayment information indicating a payment status for a loan credit, a lease credit, or the like.

For example, the communication unit 23 is constituted by a LAN interface board, a wireless communication circuit for wireless communication, and the like. The communication unit 23 exchanges information with the credit collection server 1, by the communication through the network N.

### Functional Configuration of Vehicle Information Server

Next, the functional configuration of the vehicle information server 3 will be described. The vehicle information server 3 acquires the use situation information from the vehicle 4 and sends the acquired use situation information to the credit collection server 1, in accordance with a request from the credit collection server 1. The vehicle information server 3 includes a control unit 31, a vehicle information DB 32, and a communication unit 33.

For example, the control unit 31 is realized by a processor constituted by a CPU and the like, and a memory (main storage unit) constituted by a RAM, a ROM, and the like. The control unit 31 acquires the use situation information from the vehicle 4 and sends the acquired use situation information to the credit collection server 1, in accordance with the request from the credit collection server 1.

The vehicle information DB 32 associates and stores the use situation information acquired from the vehicle 4 (object vehicle) and the information (for example, the vehicle identification number (VIN number)) for specifying the vehicle 4. The vehicle information DB 32 sends the use situation information to the credit collection server 1, under the control by the control unit 31, in accordance with the request from the credit collection server 1.

For example, the communication unit 33 is constituted by a LAN interface board, a wireless communication circuit for wireless communication, and the like. The communication unit 33 exchanges information among the credit collection server 1, the credit management server 2, and the vehicle 4, by the communication through the network N.

### Functional Configuration of Vehicle

Next, the functional configuration of the vehicle 4 will be described. For example, the vehicle 4 is a general engine vehicle (CONV: Conventional Vehicle), a hybrid electric vehicle (HEV), or a plug-in hybrid electric vehicle (PHEV). Further, for example, the vehicle 4 is a fuel cell electric vehicle (FCEV) or a battery electric vehicle (BEV).

The vehicle 4 includes a memory 40, an ECU 41, the immobilizer 42, a positioning unit 43, a detection unit 44 (Bluetooth (R) detection device), an image pickup device 45, a clock 46, a weight sensor 47, an input unit 48, a communication unit 49, and a display device 50.

The memory 40 is constituted using an HDD, an SSD, or the like, and records 2-dimensional (2D) map information or 3-dimensional (3D) map information that is used by the positioning unit 43.

For example, the ECU 41 is an electronic control device (electronic control unit) that includes, as a main component part, a microcomputer constituted by a CPU, a ROM, a RAM, and the like. The ECU 41 sends the use situation information to the vehicle information server 3 in accordance with a request (remote control) from the credit collection server 1 through the vehicle information server 3. Further, the ECU 41 acquires the use situation information about the vehicle 4 that is detected by each of the positioning unit 43 and the detection unit 44 and sends the use situation information to the credit collection server 1 through the vehicle information server 3, in accordance with a request (remote control) from the credit collection server 1. Furthermore, the ECU 41 activates the engine start disability of the vehicle 4, in response to an instruction signal for giving an instruction of the activation of the engine start disability for remote control that is sent from the credit collection server 1 through the vehicle information server 3. That is, the ECU 41 performs such a control that the engine of the vehicle 4 is not started even when the debtor pushes down an ignition switch for starting the engine of the vehicle 4. In this case, the ECU 41 may display information indicating that the engine start is disabled because of the delay of the debt payment or display contact information about the creditor, on the display device 50 or the like included in the vehicle 4.

The immobilizer 42 activates or cancels the engine start disability, based on the control by the ECU 41. Specifically, the immobilizer 42 activates the engine start disability or cancels the engine start disability, under the control by the ECU 41 that depends on the remote control by the vehicle information server 3. The immobilizer 42 is realized by a processor constituted by a CPU and the like, and a memory (main storage unit) constituted by a RAM, a ROM, and the like, and records key information (ID code) for cancelling the engine start disability, in the memory. The immobilizer 42 determines whether key information included in the remote control by the vehicle information server 3 coincides with the key information recorded in the memory, and in the case of the coincidence of the key information, activates the engine start disability or cancels the engine start disability, under the control by the ECU 41 that depends on the remote control by the vehicle information server 3.

For example, the positioning unit 43 receives electric waves from global positioning system (GPS) satellites, and detects the current position of the vehicle 4. The method for detecting the current position of the vehicle 4 is not limited to the method in which GPS satellites are used, and may be a method in which a laser imaging detection and ranging (LiDAR, Light Detection and Ranging) and the 2-dimensional or 3-dimensional map information recorded in the memory 40 are combined, for example.

The detection unit 44 detects a terminal device that is positioned in the vehicle 4. Specifically, the detection unit 44 detects an identifier (UUID: Universally Unique Identifier) of a terminal device that is positioned in the vehicle 4 and that emits a Bluetooth (R) signal, and outputs the detection result to the ECU 41. The detection unit 44 is constituted using a Bluetooth receiver, a Bluetooth beacon, or the like.

The image pickup device 45 picks up the interior or exterior of the vehicle 4, generates still image data or moving image data, and outputs the still image data or moving image data to the ECU 41. The image pickup device 45 is constituted using a single or plurality of lenses, a charge couple device (CCD) or complementary metal oxide semiconductor (CMOS) that picks up a subject image formed by the lenses, and the like.

The clock 46 is constituted using a timer having a time measurement function, and the like, measures time, and outputs the time measurement result to the ECU 41.

The weight sensor 47 is provided at seats, a trunk, suspensions, and others of the vehicle 4. The weight sensor 47 measures the body weight of a passenger or user that sits in each seat, and outputs the measurement result to the ECU 41. Furthermore, the weight sensor 47 measures the weight of the vehicle 4, and outputs the measurement result to the ECU 41.

For example, the input unit 48 is realized by a touch panel, a keyboard, a pointing device, or the like. The input unit 48 accepts the input of a variety of operations by the user, and outputs signals corresponding to accepted operations, to the ECU 41.

For example, the communication unit 49 is constituted by a data communication module (DCM) and the like. The communication unit 49 exchanges information with the vehicle information server 3, by the communication through the network N.

For example, the display device 50 is realized by a liquid crystal display (LCD), an organic EL display (OLED), or the like. The display device 50 displays a variety of information under the control by the ECU 41.

### Terminal Device

Next, the terminal device 5 will be described. For example, the terminal device 5 is an information processing terminal such as a portable telephone. The terminal device 5 accepts the input of a variety of operations by the debtor. Specifically, in the case where the engine start is disabled by the immobilizer 42 of the vehicle 4, the terminal device 5 accepts debtor's input of the use purpose information that is relevant to the purpose of the use of the vehicle 4 and that is information for cancelling the disability of the engine start of the vehicle 4 through the credit management server 2 or the credit collection server 1. Further, the terminal device 5 sends the accepted use purpose information to the credit collection server 1 or the credit management server 2. The use purpose information includes a reason for debtor's use of the vehicle 4, a destination, a use date and hour, a use time, and the like.

### Exchange of Information among Devices in Vehicle Control System

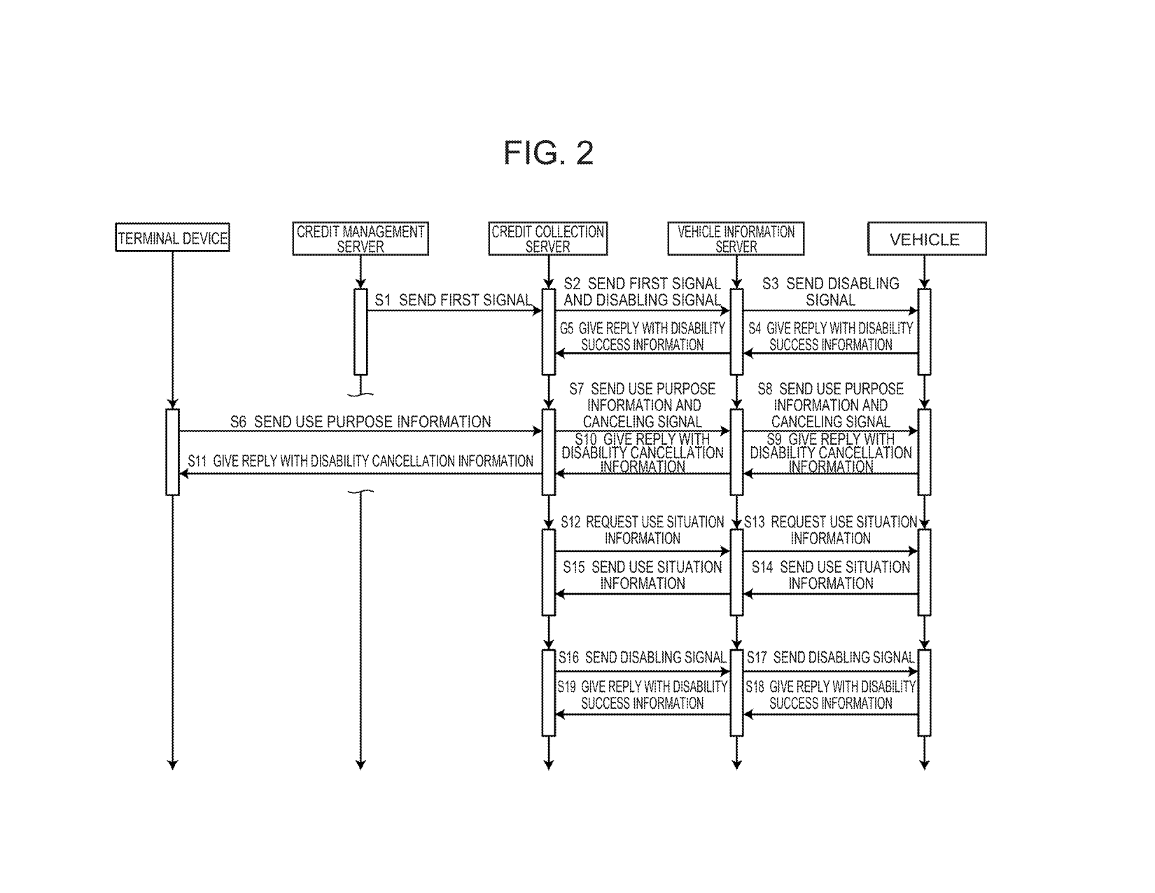

Next, the exchange of information among the credit collection server 1, the credit management server 2, the vehicle information server 3, the vehicle 4, and the terminal device 5 will be described. FIG. 2 is a sequence diagram showing an example of the exchange of information among the credit collection server 1, the credit management server 2, the vehicle information server 3, the vehicle 4, and the terminal device 5. A process for a vehicle 4 (object vehicle) that is of a plurality of vehicles 4 and that is used by a debtor that has delayed the payment for the credit will be described below as an example.

As shown in FIG. 2, first, in the case where the control unit 11 of the credit collection server 1 receives, from the credit management server 2, a first signal (hereinafter referred to as merely "first signal") indicating that the payment of the debt for the vehicle 4 (object vehicle) has not been properly performed (step S1), the control unit 11 disables the engine start of the vehicle 4 by remote control. Specifically, for disabling the engine start of the vehicle 4 by remote control, that is, for performing a remote disabling control, the control unit 11 of the credit collection server 1 sends the first signal and a disabling signal for requesting the disabling of the engine start of the vehicle 4, to the vehicle information server 3 (step S2). Subsequently, based on the first signal and disabling signal received from the credit collection server 1, the vehicle information server 3 sends the disabling signal by which the credit collection server 1 disables the engine start of the vehicle 4 by remote control and by which the vehicle 4 is requested to disable the engine start (step S3). In response to this, the vehicle 4 disables the engine start, and gives a reply with success information about the activation of the engine start disability, to the vehicle information server 3 (step S4). Specifically, the vehicle 4 gives, to the vehicle information server 3, a reply with the success information about the activation of the engine start disability under the remote control by the vehicle information server 3. Thereafter, the vehicle information server 3 sends the reply with the success information that is received from the vehicle 4, to the credit collection server 1 (step S5). In this case, the credit collection server 1 associates and stores the success information that indicates the activation of the engine start disability of the vehicle 4 by remove control and that is received from the vehicle information server 3 and the vehicle identification number (VIN number) of the vehicle 4, in the vehicle history DB 12.

Next, in the case where the terminal device 5 accepts the input of the use purpose information for temporarily using the vehicle 4 in which the engine start is disabled, in response to the operation input from the debtor, the terminal device 5 sends the accepted use purpose information to the credit collection server 1 (step S6). Subsequently, the credit collection server 1 retrieves the vehicle identification number of the vehicle 4 that is stored in the vehicle history DB 12, from vehicle identification numbers linked with the identification information about the terminal device 5 that is included in the use purpose information, and sends a cancelling signal for cancelling the disability of the engine start of the vehicle 4 by remote control and the use purpose information, to the vehicle information server 3 (step S7). In this case, the control unit 11 of the credit collection server 1 determines whether the use reason included in the use purpose information is a previously expected use reason, and sends the cancelling signal for cancelling the disability of the engine start of the vehicle 4 and the use purpose information to the vehicle information server 3, in the case of the previously expected use reason, that is, in the case of the use for the intended purpose. On the other hand, in the case where the use reason is not the previously expected use reason, that is, in the case where the control unit 11 of the credit collection server 1 determines that the use reason is not the use for the intended purpose, the control unit 11 does not send the cancelling signal for cancelling the disability of the engine start of the vehicle 4. Examples of the previously expected use reason include use for the movement of the debtor to a hospital, use for the transportation of debtor's family member to a hospital or a school, movement use for buying daily necessities, and movement use for evacuation at the time of disaster such as an earthquake and a heavy rain. The previously expected use reason is recorded in the vehicle history DB 12 and the memory 40 of the vehicle 4. Further, in the vehicle history DB 12, the vehicle identification number (VIN number) and others of the vehicle 4 and the use reason are associated and recorded. Thereafter, the vehicle information server 3 sends, to the vehicle 4, the use purpose information and the cancelling signal by which the credit collection server 1 cancels the disability of the engine start of the vehicle 4 by remote control (step S8). In response to this, the vehicle 4 cancels the disability of the engine start in accordance with the remote control for the disability of the engine start of the vehicle 4 by the credit collection server 1, and gives a reply with disability cancellation information indicating that the engine start disability has been cancelled, to the vehicle information server 3 (step S9). Thereafter, the vehicle information server 3 sends the reply with the disability cancellation information that is received from the vehicle 4, to the credit collection server 1 (step S10). In this case, the credit collection server 1 associates and stores the disability cancellation information that is received from the vehicle information server 3 and that indicates the cancellation of the engine start disability of the vehicle 4 and the vehicle identification number (VIN number) of the vehicle 4, in the vehicle history DB 12. Then, the credit collection server 1 sends the reply with the disability cancellation information that is received from the vehicle information server 3, to the terminal device 5 (step S11). Thereby, the debtor can know that the disability of the engine start of the vehicle 4 has been temporarily cancelled.

Next, for example, the credit collection server 1 requests the vehicle information server 3 to send the use situation information about the vehicle 4 with a constant period, for acquiring the use situation information about the vehicle 4 by remote control with the constant period (step S12). Subsequently, the vehicle information server 3 requests the vehicle 4 to send the use situation information, based on the request for the use situation information that is received from the credit collection server 1 (step S13). In response to this, to the vehicle information server 3, the vehicle 4 sends, as the use situation information, one or more of the position information about the vehicle 4 that is detected by the positioning unit 43, the identification information (first identification information) about the terminal device 5 that is emitted by the terminal device 5 existing in the vehicle 4 and that is detected by the detection unit 44, the still image data or moving image data that is picked up by the image pickup device 45, the clock time information that is measured by the clock 46, and the weight result that is detected by the weight sensor 47 (step S14). Subsequently, the vehicle information server 3 sends the use situation information that is received from the vehicle 4, to the credit collection server 1 (step S15). In this case, the credit collection server 1 associates and stores the use situation information about the vehicle 4 that is received from the vehicle information server 3 and the vehicle identification number (VIN number) about the vehicle 4, in the vehicle history DB 12.

Next, the control unit 11 of the credit collection server 1 determines whether the vehicle 4 is used for the unintended purpose, based on the use situation information about the vehicle 4 and the use purpose information that is linked with the vehicle 4 (the identification information about the vehicle) and that is accepted from the terminal device 5, and sends, to the vehicle information server 3, the disabling signal for requesting disabling the engine start again by remote control, that is, by remote disabling, in the case where the control unit 11 determines that the vehicle is used for the unintended purpose (step S16). Subsequently, the vehicle information server 3 sends, to the vehicle 4, the disabling signal that is a signal for requesting disabling the engine start again and that is received from the credit collection server 1 (step S17). In response to this, the vehicle 4 disables the engine start again, in accordance with the remote control by the credit collection server 1, and gives, to the vehicle information server 3, a reply with the success information about the activation of the engine start disability (step S18). Thereafter, the vehicle information server 3 sends, to the credit collection server 1, the reply with the success information that indicates the activation of the engine start disability and that is received from the vehicle 4 (step S19). In this case, the credit collection server 1 associates and stores the success information that indicates the activation of the engine start disability of the vehicle 4 and that is received from the vehicle information server 3 and the vehicle identification number (VIN number) about the vehicle 4, in the vehicle history DB 12. Thereby, the creditor can perform the protection of the vehicle 4 for which there is the credit.

### Process in Credit Collection Server

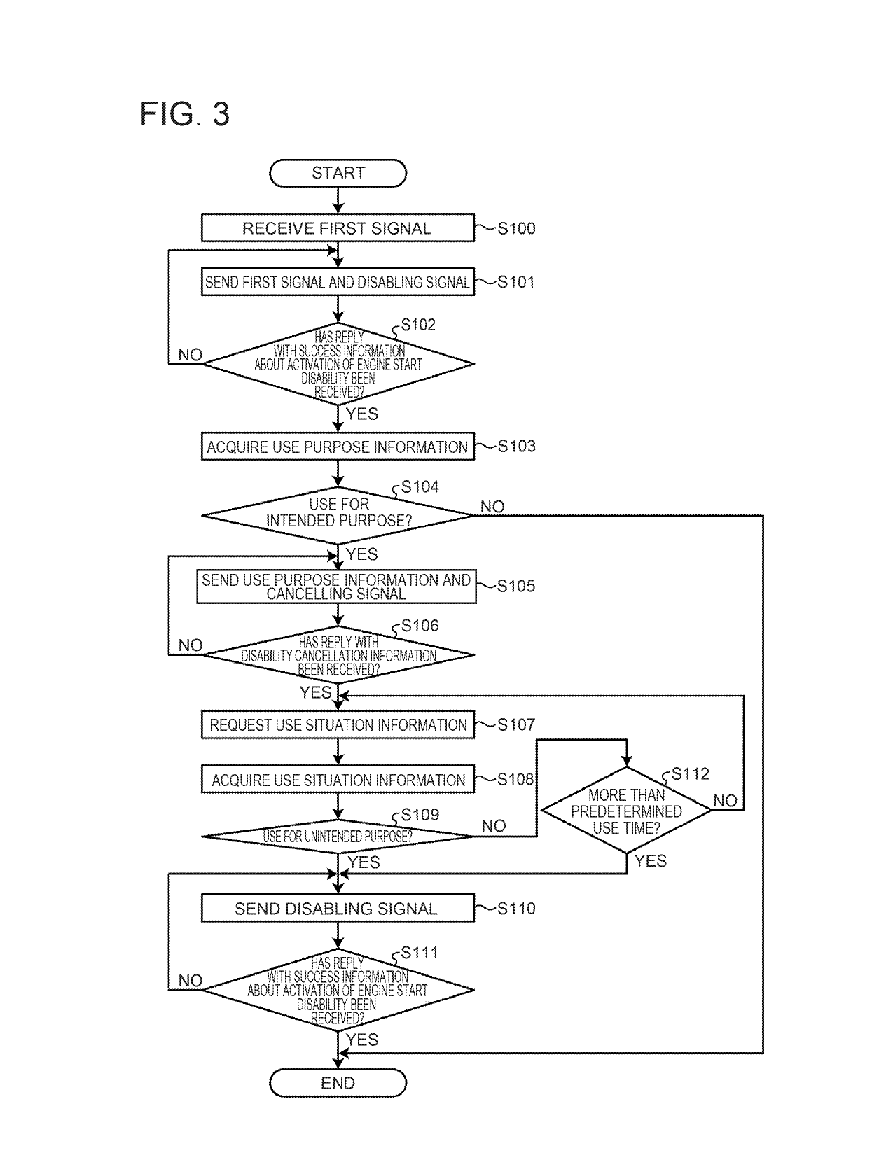

Next, a process that is executed by the credit collection server 1 will be described. FIG. 3 is a flowchart showing an outline of the process that is executed by the credit collection server 1.

As shown in FIG. 3, in the case where the control unit 11 receives the first signal from the credit management server 2 (step S100), the control unit 11 sends, to the vehicle information server 3, the first signal from the credit management server 2 and the disabling signal for requesting the disabling of the engine start of the vehicle 4 by remote control (step S101).

Subsequently, the control unit 11 determines whether the reply with the success information about the activation of the engine start disability of the vehicle 4 has been received from the vehicle information server 3 (step S102). In the case where the control unit 11 determines that the reply with the success information about the activation of the engine start disability of the vehicle 4 has been received from the vehicle information server 3 (step S102: Yes), the credit collection server 1 transitions to step S103 described later. On the other hand, in the case where the control unit 11 determines that the reply with the success information about the activation of the engine start disability of the vehicle 4 has not been received from the vehicle information server 3 (step S102: No), the credit collection server 1 returns to step S101.

Subsequently, the control unit 11 acquires the use purpose information for temporarily using the vehicle 4 in which the engine start is disabled, from the terminal device 5 through the communication unit 15 (step S103). Specifically, for example, the control unit 11 acquires the use purpose information that is input by debtor's operation of the terminal device 5 linked with the vehicle 4, from the terminal device 5.

Subsequently, the control unit 11 determines whether the use purpose information that is acquired from the terminal device 5 through the communication unit 15 and that is information for temporarily using the vehicle 4 in which the engine start is disabled indicates the use for the intended purpose (step S104). In this case, the control unit 11 determines whether the use purpose information acquired from the terminal device 5 indicates the use for the intended purpose, by determining whether the use reason included in the use purpose information is a previously expected use reason. Examples of the previously expected use reason include use for the movement of the debtor to a hospital, use for the transportation of debtor's family member to a hospital or a school, movement use for buying daily necessities, and movement use for evacuation at the time of disaster such as an earthquake and a heavy rain. That is, the control unit 11 determines whether the use purpose information indicates the use for the intended purpose, using one or more of the use reasons. Naturally, the previously expected use reasons are just examples, and additions and alterations are possible when appropriate. In the case where the control unit 11 determines that the use purpose information for temporarily using the vehicle 4 in which the engine start is disabled indicates the use for the intended purpose (step S104: Yes), the credit collection server 1 transitions to step S105 described later. On the other hand, in the case where the control unit 11 determines that the use purpose information for temporarily using the vehicle 4 in which the engine start is disabled does not indicate the use for the intended purpose (step S104: No), the credit collection server 1 ends the process.

Subsequently, the control unit 11 sends the cancelling signal that is a signal for cancelling the engine start disability of the vehicle 4 by remote control and that is a second signal indicating that the temporary use of the vehicle 4 is permitted, to the vehicle 4 through the communication unit 15 (step S105).

Subsequently, the control unit 11 determines whether the reply with the disability cancellation information indicating that the engine start disability of the vehicle 4 has been cancelled has been received from the vehicle information server 3 through the communication unit 15 (step S106). In the case where the control unit 11 determines that the reply with the disability cancellation information indicating that the engine start disability of the vehicle 4 has been cancelled has been received from the vehicle information server 3 (step S106: Yes), the credit collection server 1 transitions to step S107. On the other hand, in the case where the control unit 11 determines that the reply with the disability cancellation information indicating that the engine start disability of the vehicle 4 has been cancelled has not been received from the vehicle information server 3 (step S106: No), the credit collection server 1 returns to step S105.

Subsequently, the control unit 11 requests the vehicle information server 3 to send the use situation information about the vehicle 4 with a constant period, for acquiring the use situation information about the vehicle 4 by remote control through the communication unit 15 (step S107).

Subsequently, the control unit 11 acquires the use situation information about the vehicle 4 from the vehicle information server 3 through the communication unit 15 (step S108).

Thereafter, the control unit 11 determines whether the vehicle 4 is used for the unintended purpose, based on the use situation information about the vehicle 4 that is acquired through the vehicle information server 3 and the use purpose information that is accepted from the terminal device 5 linked with the vehicle 4 (the identification information about the vehicle) (step S109). Specifically, the control unit 11 determines whether the vehicle 4 is used for the unintended purpose, by performing one or more of the following (1) to (8).

(1) For example, the control unit 11 determines whether identification information (first identification information) that is information for identifying the terminal device existing in the vehicle 4, that is emitted by the terminal device, and that is detected by the detection unit 44 and second identification information that is information for identifying a predetermined information processing terminal and that is recorded in the vehicle history DB 12 coincide with each other. In the case where the first identification information and the second identification information do not coincide with each other, the control unit 11 determines that the vehicle 4 is used for the unintended purpose. In this case, for example, the control unit 11 determines that the vehicle 4 is used by a different user from any of the debtor that has demanded the cancellation of the engine start disability, debtor's family members, previously registered users of the vehicle 4, and the like, and controls the immobilizer 42, to disable the engine start of the vehicle 4 again. In this case, the ECU 41 accepts the disabling signal from the credit collection server 1, and controls the immobilizer 42. In this case, the immobilizer 42 does not drive the engine of the vehicle 4, even when an instruction of the start is given. At this time, the control unit 11 may display information indicating that the engine start of the vehicle 4 is disabled again, on the display device 50, or may be send the information to the terminal device 5. The second identification information does not need to be recorded in the vehicle history DB 12, and for example, whether the second information that is recorded in the vehicle history DB 12 included in the credit collection server 1 and that is information for identifying a debtor terminal (information processing terminal) of one of the debtor linked with the vehicle 4, debtor's family members, previously registered users of the vehicle 4, and the like, coincides with the identification information (first identification information) that is information for identifying the terminal device existing in the vehicle 4, that is emitted by the terminal device, and that is detected by the detection unit 44 may be determined.

(2) For example, the control unit 11 extracts a first feature quantity indicating a feature of the face of a person included in the still image data or moving image data about the interior of the vehicle 4 that is picked up by the image pickup device 45, and determines whether the coincidence degree between the first feature quantity and a second feature quantity indicating a feature of a predetermined face recorded in the vehicle history DB 12 is less than a predetermined value. For example, the predetermined face is the face of one of the debtor linked with the vehicle 4, debtor's relatives, previously registered users of the vehicle 4, and the like. In the case where the coincidence degree between the first feature quantity and the second feature quantity is less than the predetermined value, for example, in the case where the coincidence degree is less than 80%, the control unit 11 determines that the vehicle 4 is used by a different user from the person that has demanded the cancellation of the engine start disability, for example, the debtor, that is, determines that the vehicle 4 is used for the unintended purpose, and controls the immobilizer 42, to disable the engine start of the vehicle 4 again. The control unit 11 may extract the feature quantity by performing a well-known feature quantity extraction process, for example, an extraction process allowing the extraction of a Haar-Like feature quantity, a HOG feature quantity, or a SIFT feature quantity, to a still image corresponding to the still image data or a moving image corresponding to the moving image data. Naturally, the control unit 11 may extract the feature quantity using an after-learning model for which machine learning such as deep learning has been performed, that receives the still image data or the moving image data, and that outputs the feature quantity of the face of the person.

(3) For example, the control unit 11 determines whether the difference between the weight result (weight information) that is detected by the weight sensor 47 and that indicates the weight of a user (passenger) that sits in the seat and weight information about a predetermined person that is recorded in the vehicle history DB 12 is a predetermined value or more. Examples of the predetermined person include the debtor linked with the vehicle 4, debtor's relatives, and previously registered users. In the case where the difference between the weight result that is detected by the weight sensor 47 and that indicates the weight of the user that sits in the seat and the weight information that is recorded in the vehicle history DB 12 and that is information about the debtor linked with the vehicle 4 is the predetermined value or more, for example, in the case where the difference is 5 kg or more, the control unit 11 determines that the vehicle 4 is used by a different user from the user (debtor) that has demanded the cancellation of the engine start disability, that is, determines that the vehicle 4 is used for the unintended purpose, and controls the immobilizer 42, to disable the engine start of the vehicle 4 again.

(4) For example, the control unit 11 extracts a text and an architectural structure that are included in still image data or moving image data about the exterior of the vehicle 4 that is picked up by the image pickup device 45, and based on at least one of the extraction result and a predetermined destination included in the use purpose information, the control unit 11 determines whether the vehicle 4 is moving to the destination. Examples of the predetermined destination include destination information input by the debtor, debtor's relatives, or the like, and workplace information about the debtor, debtor's relatives, or the like. In this case, the control unit 11 extracts the text and architectural structure that are included in the still image data or the moving image data, using an after-learning model for which machine learning such as deep learning has been previously performed, that receives the still image data or the moving image data, and that outputs the name of the architectural structure or the text. Then, in the case where the control unit 11 determines that the vehicle 4 is not moving to the destination, the control unit 11 determines that the vehicle 4 is not going toward the destination demanded by the debtor, that is, determines that the vehicle 4 is used for the unintended purpose, and controls the immobilizer 42, to disable the engine start of the vehicle 4 again. In this case, the control unit 11 may give warning on the display device 50 for a predetermined time, for example, for about five minutes, before disabling the engine start of the vehicle 4 again, and then, may control the immobilizer 42, to disable the engine start of the vehicle 4 again. Naturally, in the case where the vehicle 4 moves toward the destination after the warning on the display device 50, the control unit 11 may stop the warning. The control unit 11 may determine whether the vehicle 4 is moving to the destination, based on the extraction result about the text and architectural structure extracted from the still image data or moving image data about the exterior of the vehicle 4 that is picked up by the image pickup device 45, the predetermined destination that is included in the use purpose information, and map information that includes feature quantities of at least a text and an architectural structure and that is recorded in the vehicle history DB 12.

(5) For example, in the case where the vehicle 4 has arrived at the destination based on the position information about the vehicle 4, the control unit 11 extracts a text and a facility that are included in still image data or moving image data about the exterior of the vehicle 4 that is picked up by the image pickup device 45, and based on the extraction result and a facility at the predetermined destination that is included in the use purpose information, the control unit 11 determines whether the vehicle 4 has entered the facility. In this case, the control unit 11 extracts the text or facility that are included in the still image data or the moving image data, using an after-learning model for which machine learning such as deep learning has been previously performed, that receives the still image data or the moving image data, and that outputs the name of the facility or the text. Then, in the case where the control unit 11 determines that the vehicle 4 has not entered the facility, the control unit 11 determines that the vehicle 4 is not in the facility at the destination that is demanded by the debtor, that is, determines that the vehicle 4 is used for the unintended purpose, and controls the immobilizer 42, to disable the engine start of the vehicle 4 again. At this time, the control unit 11 may give warning on the display device 50 for a predetermined time, for example, for about five minutes, before disabling the engine start of the vehicle 4 again, and then, may control the immobilizer 42, to disable the engine start of the vehicle 4 again. Naturally, in the case where the vehicle 4 moves toward the interior of the facility after the warning on the display device 50, the control unit 11 may stop the warning. In the case where the vehicle 4 has arrived at the destination, the control unit 11 may extract the text and a facility that are included in the still image data or moving image data about the exterior of the vehicle 4 that is picked up by the image pickup device 45, and based on the extraction result, the facility at the predetermined destination that is included in the use purpose information, and map information that includes feature quantities of at least a text and a facility and that is recorded in the vehicle history DB 12, the control unit 11 may determine whether the vehicle 4 has entered the facility.

(6) For example, the control unit 11 determines whether the weight detected by the weight sensor 47 is a predetermined threshold or more, and in the case where the weight is the predetermined threshold or more, the control unit 11 determines that a burden having a weight other than a weight for the use purpose is loaded on the vehicle 4, that is, determines that the vehicle 4 is used for the unintended purpose, and controls the immobilizer 42, to disable the engine start of the vehicle 4 again. In this case, there is a possibility that the user of the vehicle 4 loads a burden having a weight that is expected by the creditor, and for the protection of the vehicle 4 that is the credit, the control unit 11 controls the immobilizer 42, to disable the engine start of the vehicle 4 again. Thereby, the creditor can perform the protection of the vehicle 4 that is the credit.

(7) For example, based on the position information about the vehicle 4 and a predetermined destination that is demanded by the debtor and that is included in the use purpose information, the control unit 11 determines whether the vehicle 4 has moved in a direction away from the destination for a predetermined time. For example, in the case where the vehicle 4 has moved in the direction away from the destination for the predetermined time, the control unit 11 determines that the vehicle 4 is used for the unintended purpose, and remotely controls the immobilizer 42, to disable the engine start of the vehicle 4 again. In this case, the control unit 11 can perform the protection of the vehicle 4 that is the credit, while preventing a false application by a malicious debtor.

(8) For example, the control unit 11 determines whether the time of the use of the vehicle 4 after the engine start disability of the vehicle 4 is cancelled has exceeded a predetermined use time included in the use purpose information, and in the case where the time of the use of the vehicle 4 has exceeded the predetermined use time, the control unit 11 determines that the vehicle 4 is used for the unintended purpose, and remotely controls the immobilizer 42, to disable the engine start of the vehicle 4 again.

In this way, the control unit 11 determines whether the vehicle 4 is used for the unintended purpose, by performing one or more of the above (1) to (8). In the case where the control unit 11 determines that the vehicle 4 is used for the unintended purpose (step S109: Yes), the credit collection server 1 transitions to step S110. On the other hand, in the case where the control unit 11 determines that the vehicle 4 is not used for the unintended purpose (step S109: No), the credit collection server 1 transitions to step S112.

Subsequently, the control unit 11 sends the disabling signal for requesting the disabling of the engine start of the vehicle 4 by remote control, to the vehicle information server 3 (step S110).

Subsequently, the control unit 11 determines whether the reply with the success information about the activation of the engine start disability of the vehicle 4 has been received from the vehicle information server 3 (step S111). In the case where the control unit 11 determines that the reply with the success information about the activation of the engine start disability of the vehicle 4 has been received from the vehicle information server 3 (step S111: Yes), the credit collection server 1 ends the process. On the other hand, in the case where the control unit 11 determines that the reply with the success information about the activation of the engine start disability of the vehicle 4 has not been received from the vehicle information server 3 (step S111: No), the credit collection server 1 returns to step S110.

Subsequently, the control unit 11 determines whether the elapsed time after the engine start disability is cancelled has exceeded a predetermined use time. The predetermined use time is a use time for the vehicle 4 that is demanded by the debtor, or a use time that is previously determined by the creditor. Examples of the predetermined use time include a time until a date that is demanded by the debtor for the use and a time until 24 hours elapses from a time clock that is demanded by the debtor for the use. Naturally, the use time may be a time resulting from multiplying the use time for the vehicle 4 that is demanded by the debtor, by a coefficient. In the case where the control unit 11 determines that the elapsed time after the engine start disability is cancelled has exceeded the predetermined time (step S112: Yes), the credit collection server 1 transitions to step S110. On the other hand, in the case where the control unit 11 determines that the elapsed time after the engine start disability is cancelled has not exceeded the predetermined time (step S112: No), the credit collection server 1 returns to step S107.

### Process 1 in Vehicle Information Server

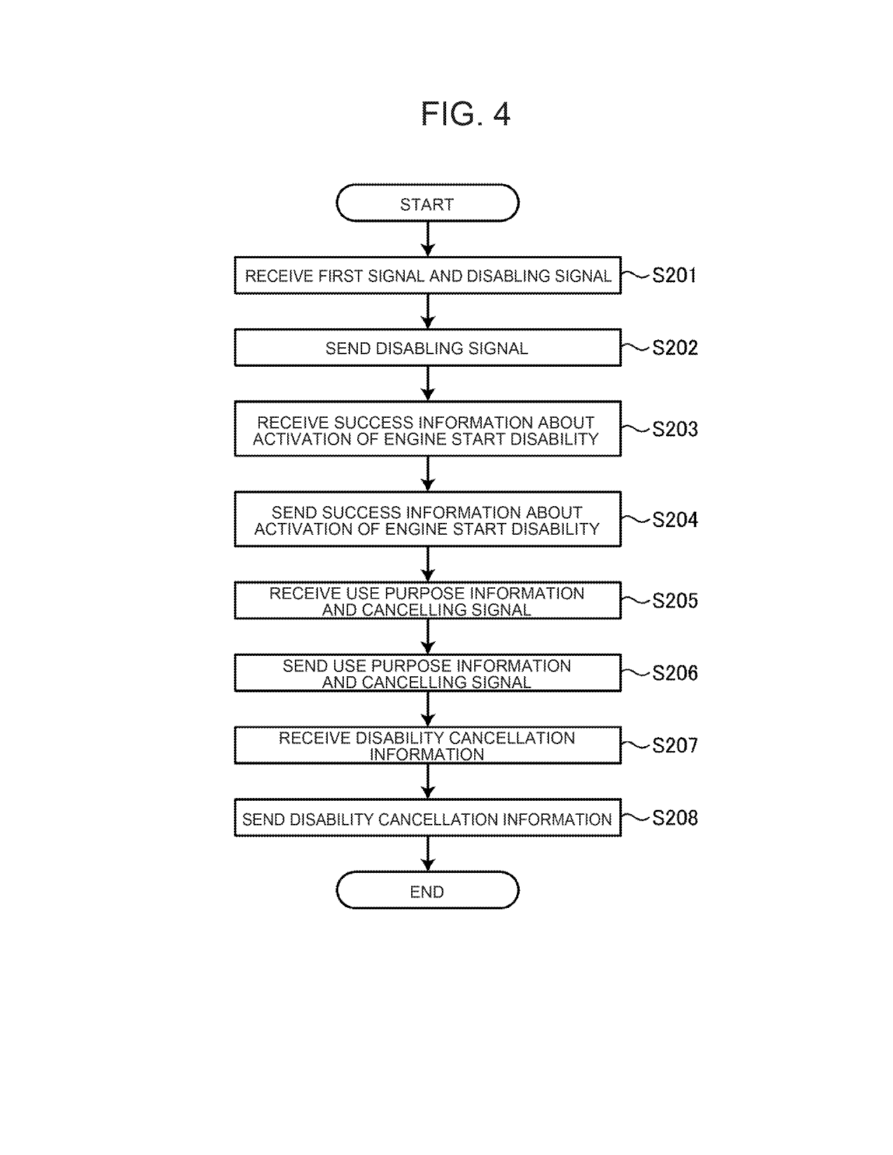

Next, an outline of a process that is executed by the vehicle information server 3 when the engine start disability is cancelled after the engine start of the vehicle 4 is disabled will be described. FIG. 4 is a flowchart showing the outline of the process that is executed by the vehicle information server 3 when the engine start disability is cancelled after the engine start of the vehicle 4 is disabled.

As shown in FIG. 4, first, the control unit 31 of the vehicle information server 3 receive the first signal indicating that the payment by the debtor has not been properly performed and the disabling signal for requesting the disabling of the engine start of the vehicle 4 by remote control, from the credit collection server 1 (step S201).

Subsequently, the control unit 31 sends the disabling signal that is received from the credit collection server 1 and that is a signal for requesting the disabling of the engine start of the vehicle 4 by remote control, to the vehicle 4 (step S202).

Thereafter, the control unit 31 receives the success information about the activation of the engine start disability, from the vehicle 4 (step S203), and sends the success information about the activation of the engine start disability, to the credit collection server 1 (step S204).

Subsequently, the control unit 31 receives the use purpose information about the debtor and the cancelling signal for cancelling the engine start disability of the vehicle 4, from the credit collection server 1 (step S205), and sends the use purpose information about the debtor and the cancelling signal for cancelling the engine start disability of the vehicle 4, to the vehicle 4 (step S206).

Subsequently, the control unit 31 receives the reply that is received from the vehicle 4 and that includes the disability cancellation information indicating that the engine start disability of the vehicle 4 has been cancelled (step S207), and sends the disability cancellation information indicating that the engine start disability of the vehicle 4 has been cancelled, to the credit collection server 1 (step S208). After step S208, the vehicle information server 3 ends the process.

### Process 2 in Vehicle Information Server

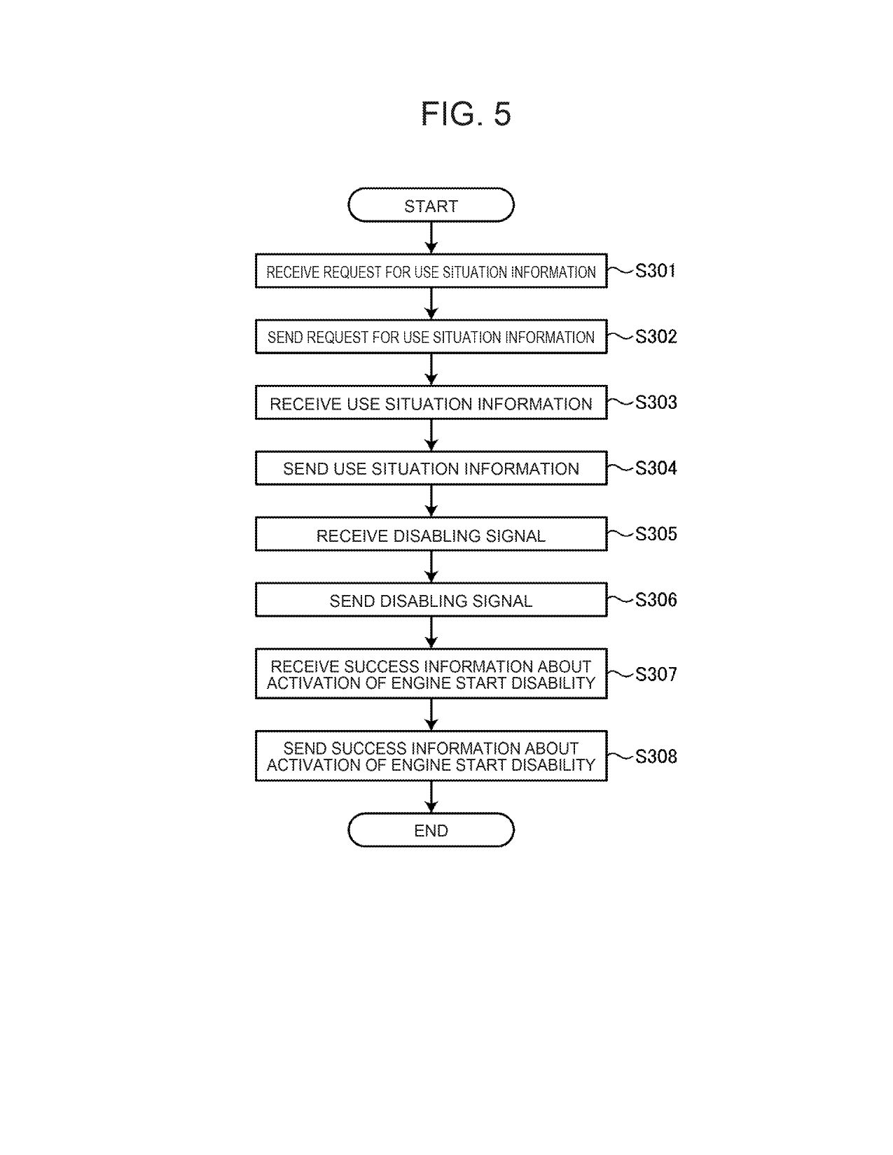

Next, an outline of a process that is executed by the vehicle information server 3 when the engine start is disabled again after the engine start disability of the vehicle 4 is cancelled will be described. FIG. 5 is a flowchart showing the outline of the process that is executed by the vehicle information server 3 when the engine start is disabled again after the engine start disability of the vehicle 4 is cancelled.

As shown in FIG. 5, based on the request for the use situation information that is received from the credit collection server 1, the control unit 31 receives the request for the use situation information about the vehicle 4 (step S301), and sends the request for the use situation information to the vehicle 4 (step S302).

Subsequently, the control unit 31 receives the use situation information from the vehicle 4 (step S303), and sends the use situation information received from the vehicle 4, to the credit collection server 1 (step S304).

Thereafter, the control unit 31 receives the disabling signal for requesting the disabling of the engine start of the vehicle 4 by remote control, from the credit collection server 1 (step S305), and sends the disabling signal that is received from the credit collection server 1 and that is a signal for requesting the disabling of the engine start of the vehicle 4 by remote control, to the vehicle 4 (step S306).

Subsequently, the control unit 31 receives the success information about the activation of the engine start disability, from the vehicle 4 (step S307), and sends the success information about the activation of the engine start disability, to the credit collection server 1 (step S308). After step S308, the vehicle information server 3 ends the process.

### Process 1 in Vehicle

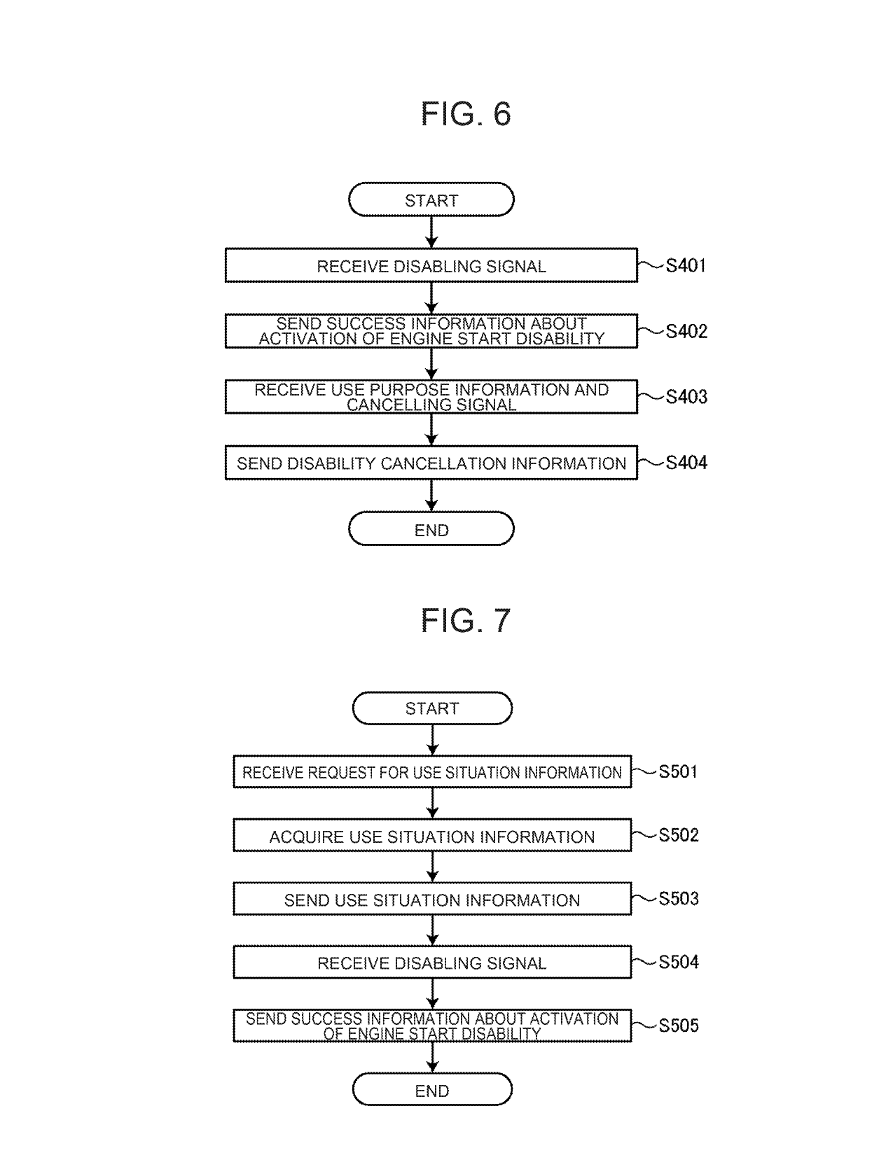

Next, an outline of a process that is executed by the vehicle 4 when the engine start disability is cancelled after the engine start is disabled will be described. FIG. 6 is a flowchart showing the outline of the process that is executed by the vehicle 4 when the engine start disability is cancelled after the engine start is disabled.

As shown in FIG. 6, first, the ECU 41 receives the disabling signal for requesting the disabling of the engine start of the vehicle 4 by remote control, from the credit collection server 1 through the vehicle information server 3 (step S401). In response to the disabling signal, the ECU 41 controls the immobilizer 42, to disable the engine start, and sends the success information about the activation of the engine start disability, to the vehicle information server 3 (step S402).

Subsequently, the ECU 41 receives the use purpose information about the debtor and the cancelling signal for cancelling the engine start disability of the vehicle 4, from the credit collection server 1 through the vehicle information server 3 (step S403), controls the immobilizer 42, to cancel the engine start disability, and sends the disability cancellation information indicating that the engine start disability has been cancelled, to the vehicle information server 3 (step S404). After step S404, the vehicle 4 ends the process.

### Process 2 in Vehicle

Next, an outline of a process that is executed by the vehicle 4 when the engine start is disabled again after the engine start disability is cancelled will be described. FIG. 7 is a flowchart showing the outline of the process that is executed by the vehicle 4 when the engine start is disabled again after the engine start disability is cancelled.

As shown in FIG. 7, first, the ECU 41 receives the request for the use situation information from the credit collection server 1 through the vehicle information server 3 (step S501), and in response to the request for the use situation information, the ECU 41 acquires the use situation information (step S502). Specifically, the ECU 41 acquires, as the use situation information, one or more of the position information about the vehicle 4 that is detected by the positioning unit 43, the identification information (first identification information) that is information about the terminal device existing in the vehicle 4, that is emitted by the terminal device, and that is detected by the detection unit 44, the still image data or moving image data that is picked up by the image pickup device 45, the clock time information that is measured by the clock 46, and the weight result that is detected by the weight sensor 47.

Subsequently, the ECU 41 sends the use situation information to the vehicle information server 3 (step S503). In this case, the ECU 41 sends the use situation information that is designated by remote control from the credit collection server 1 through the vehicle information server 3. For example, in the case where the identification information (first identification information) that is information about the terminal device existing in the vehicle 4, that is emitted by the terminal device, and that is detected by the detection unit 44 is designated from the credit collection server 1, the ECU 41 sends, as the use situation information, the identification information (first identification information) that is information about the terminal device existing in the vehicle 4, that is emitted by the terminal device, and that is detected by the detection unit 44, to the vehicle information server 3. Naturally, as the use situation information, the ECU 41 may send a plurality of pieces of information, for example, the position information about the vehicle 4 that is detected by the positioning unit 43 and the still image data or moving image data that is picked up by the image pickup device 45, to the vehicle information server 3.

Thereafter, the ECU 41 receives the disabling signal for requesting the disabling of the engine start of the vehicle 4 by remote control, from the vehicle information server 3 (step S504). In response to the disabling signal, the ECU 41 controls the immobilizer 42, to disable the engine start again, and sends the success information about the activation of the engine start disability, to the vehicle information server 3 (step S505). After step S505, the vehicle 4 ends the process.

In the embodiment 1 described above, in the case where the control unit 11 determines that the vehicle 4 is used for the unintended purpose after the disability of the engine start of the vehicle 4 is cancelled by remote control, the control unit 11 disables the engine start of the vehicle 4 again. Therefore, it is possible to perform the protection of the credit, to achieve the credit collection, and to flexibly use the vehicle 4.

Further, in the embodiment 1, in the case where the control unit 11 receives the use purpose information about the vehicle 4 from the terminal device 5 (debtor terminal device) linked with the vehicle 4, the control unit 11 determines whether the temporary use of the vehicle 4 is permitted, based on the use purpose information, and in the case where the temporary use of the vehicle 4 is permitted, the control unit 11 performs the remote cancelling control by outputting, to the immobilizer of the vehicle 4, the cancelling signal that is the second signal for cancelling the disability of the engine start by remote control. Therefore, it is possible to perform the protection of the credit, to achieve the credit collection, and to flexibly use the vehicle 4.

Further, in the embodiment 1, the control unit 11 determines whether the identification information (first identification information) that is information for identifying the terminal device existing in the vehicle 4, that is emitted by the terminal device, and that is detected by the detection unit 44 and second identification information that is information for identifying the predetermined information processing terminal and that is recorded in the vehicle history DB 12 coincide with each other. In the case where the first identification information and the second identification information do not coincide with each other, the control unit 11 determines that the vehicle 4 is used for the unintended purpose. Therefore, it is possible to perform the protection of the vehicle 4 in the case of the use for the unintended purpose.

Further, in the embodiment 1, the control unit 11 extracts the first feature quantity indicating the feature of the person included in the still image data or moving image data about the interior of the vehicle 4 that is picked up by the image pickup device 45, and determines whether the coincidence degree between the first feature quantity and the second feature quantity indicating the feature of the predetermined face recorded in the vehicle history DB 12 is less than the predetermined value. Therefore, it is possible to perform the protection of the vehicle 4 in the case of the use for the unintended purpose.

Further, in the embodiment 1, the control unit 11 determines whether the difference between the weight result that is detected by the weight sensor 47 and that indicates the weight of the user that sits in the seat and the weight information about the predetermined person that is recorded in the vehicle history DB 12 is the predetermined value or more. Therefore, it is possible to perform the protection of the vehicle 4 in the case of the use for the unintended purpose.

Further, in the embodiment 1, the control unit 11 extracts the text and architectural structure that are included in the still image data or moving image data about the exterior of the vehicle 4 that is picked up by the image pickup device 45, and based on the at least one of the extraction result and the predetermined destination included in the use purpose information, the control unit 11 determine whether the vehicle 4 is moving to the destination. Therefore, it is possible to perform the protection of the vehicle 4 in the case of the use for the unintended purpose.

Further, in the embodiment 1, in the case where the vehicle 4 has arrived at the destination, the control unit 11 extracts the text and a facility that are included in the still image data or moving image data about the exterior of the vehicle 4 that is picked up by the image pickup device 45, and based on the extraction result and the facility at the predetermined destination that is included in the use purpose information, the control unit 11 determines whether the vehicle 4 has entered the facility. Therefore, it is possible to perform the protection of the vehicle 4 in the case of the use for the unintended purpose.

Further, in the embodiment 1, the control unit 11 determines whether the weight detected by the weight sensor 47 is the predetermined threshold or more, and in the case where the weight is the predetermined threshold or more, the control unit 11 determines that a burden having a weight other than a weight for the use purpose is loaded on the vehicle 4, that is, determines that the vehicle 4 is used for the unintended purpose, and controls the immobilizer 42, to disable the engine start of the vehicle 4 again. Therefore, it is possible to perform the protection of the vehicle 4 in the case of the use for the unintended purpose.

Further, in the embodiment 1, based on the position information about the vehicle 4 and the predetermined destination that is demanded by the debtor and that is included in the use purpose information, the control unit 11 determines whether the vehicle 4 has moved in the direction away from the destination for the predetermined time. Therefore, it is possible to perform the protection of the vehicle 4 that is the credit, while preventing the false application by the malicious debtor.

Further, in the embodiment 1, the control unit 11 determines whether the time of the use of the vehicle 4 after the engine start disability of the vehicle 4 is cancelled has exceeded the predetermined use time included in the use purpose information, and in the case where the time of the use of the vehicle 4 has exceeded the predetermined use time, the control unit 11 controls the immobilizer 42, to disable the engine start of the vehicle 4 again. Therefore, it is possible to perform the protection of the vehicle 4 in the case of the use for the unintended purpose.

### Embodiment 2

Next, an embodiment 2 will be described. In the embodiment 1, the control unit 11 of the credit collection server 1 remotely determines whether the vehicle 4 for which the use is demanded by the debtor and in which the engine start disability is cancelled is used for the unintended purpose, based on the use situation information acquired from the vehicle 4, but in the embodiment 2, the vehicle 4 determines whether the vehicle 4 is used for the unintended purpose. That is, the vehicle control system according to the embodiment 2 has the same configuration as the vehicle control system 100 according to the embodiment 1, and the process that is executed by the vehicle 4 is different. Therefore, the process that is executed by the vehicle 4 according to the embodiment 2 will be described. In the following description, the same compositions as those in the vehicle control system 100 according to the embodiment 1 are denoted by the same reference characters, and detailed descriptions thereof are omitted.

### Process 3 in Vehicle

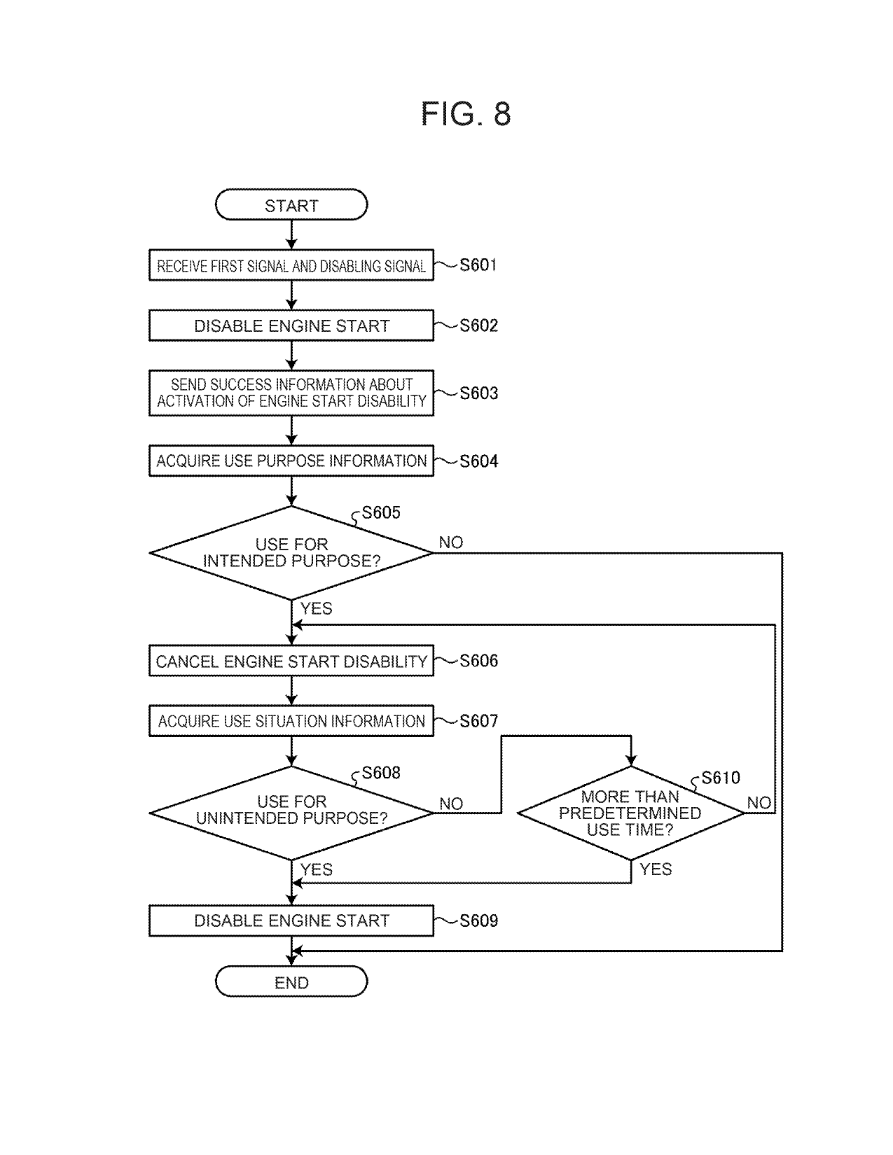

FIG. 8 is a flowchart showing an outline of a process that is executed by a vehicle 4 according to the embodiment 2.

As shown in FIG. 8, first, the ECU 41 receives the first signal and the disabling signal for requesting the disabling of the engine start of the vehicle 4 by remote control, from the credit collection server 1 through the vehicle information server 3 and the communication unit 49 (step S601), and controls the immobilizer 42, to disable the engine start, in response to the first signal and the disabling signal (step S602). For example, the ECU 41 sets a flag such that the immobilizer 42 does not react even when a start button of the vehicle 4 is pushed down.

Subsequently, for example, the ECU 41 determines whether the activation of the engine start disability succeeds, based on the operation situation of the immobilizer 42, and in the case where the activation of the engine start disability succeeds, the ECU 41 sends the success information about the activation of the engine start disability to the credit collection server 1 through the communication unit 49 and the vehicle information server 3 (step S603).

Subsequently, the ECU 41 acquires the use purpose information for temporarily using the vehicle 4 in which the engine start is disabled, from the terminal device 5 through the communication unit 49 (step S604). Specifically, for example, the ECU 41 acquires the use purpose information that the debtor inputs by operating the terminal device 5.

Subsequently, the ECU 41 determines whether the use purpose information that is acquired from the terminal device 5 through the communication unit 49 and that is information for temporarily using the vehicle 4 in which the engine start is disabled indicates the use for the intended purpose (step S605). In this case, the ECU 41 determines whether the use purpose information indicates the use for the intended purpose, by determining whether the use reason included in the use purpose information acquired from the terminal device 5 is a previously expected use reason. Examples of the previously expected use reason include use for the movement of the debtor to a hospital, use for the transportation of debtor's family member to a hospital or a school, movement use for buying daily necessities, and movement use for evacuation at the time of disaster such as an earthquake and a heavy rain. That is, the ECU 41 determines whether the use purpose information indicates the use for the intended purpose, using one or more of the use reasons. Naturally, the previously expected use reasons are just examples, and additions and alterations are possible when appropriate. The previously expected use reason is recorded in the memory 40 of the vehicle 4, or the like. In the case where the ECU 41 determines that the use purpose information for temporarily using the vehicle 4 in which the engine start is disabled indicates the use for the intended purpose (step S605: Yes), the vehicle 4 transitions to step S606 described later. On the other hand, in the case where the ECU 41 determines that the use purpose information for temporarily using the vehicle 4 in which the engine start is disabled does not indicate the use for the intended purpose (step S605: No), the vehicle 4 ends the process.

In the case where the ECU 41 determines in step S605 that the use purpose information indicates the use for the intended purpose (step S605: Yes), the ECU 41 controls the immobilizer 42, to cancel the engine start disability (step S606). For example, the ECU 41 cancels the engine start disability, by unsetting the flag such that the immobilizer 42 reacts when the start button of the vehicle 4 is pushed down.

Subsequently, the ECU 41 acquires the use situation information (step S607). Specifically, for example, the ECU 41 acquires, as the use situation information, one or more of the position information about the vehicle 4 that is detected by the positioning unit 43, the identification information (first identification information) that is information about the terminal device existing in the vehicle 4, that is emitted by the terminal device, and that is detected by the detection unit 44, the still image data or moving image data that is picked up by the image pickup device 45, the clock time information that is measured by the clock 46, and the weight result that is detected by the weight sensor 47.

Subsequently, the ECU 41 determines whether the vehicle 4 is used for the unintended purpose, based on the use situation information and the use purpose information acquired in step S604 (step S608). Specifically, the ECU 41 determines whether the vehicle 4 is used for the unintended purpose, by performing one or more of the following (1) to (8).

(1) For example, the ECU 41 determines whether identification information (first identification information) that is information for identifying the terminal device existing in the vehicle 4, that is emitted by the terminal device, and that is detected by the detection unit 44 and second identification information that is information for identifying the debtor terminal of the debtor linked with the vehicle 4 and that is recorded in the memory 40 coincide with each other. In the case where the first identification information and the second identification information do not coincide with each other, the ECU 41 determines that the vehicle 4 is used for the unintended purpose. In this case, for example, the ECU 41 determines that the vehicle 4 is used by a different user from any of the debtor that has demanded the cancellation of the engine start disability, debtor's family members, users of the vehicle 4 that are previously registered in the memory 40, and the like, and controls the immobilizer 42, to disable the engine start of the vehicle 4 again. At this time, the ECU 41 may display a message indicating that the engine start of the vehicle 4 is disabled again, on the display device 50, or may send the message to the terminal device 5. The second identification information does not need to be recorded in the memory 40, and whether the second information that is recorded in the vehicle history DB 12 included in the credit collection server 1 and that is information for identifying the debtor terminal of the debtor linked with the vehicle 4 coincides with the identification information (first identification information) that is information for identifying the terminal device existing in the vehicle 4, that is emitted by the terminal device, and that is detected by the detection unit 44 may be determined.

(2) For example, the ECU 41 extracts a first feature quantity indicating a feature of the face of a person included in the still image data or moving image data about the interior of the vehicle 4 that is picked up by the image pickup device 45, and determines whether the coincidence degree between the first feature quantity and a second feature quantity indicating a feature of a predetermined face linked with the vehicle 4 that is recorded in the memory 40 is less than a predetermined value. The predetermined face is the face of one of the debtor, debtor's family members, and previously registered users of the vehicle 4. In this case, in the case where the coincidence degree between the first feature quantity and the second feature quantity is less than the predetermined value, for example, in the case where the coincidence degree is less than 80%, the ECU 41 determines that the vehicle 4 is used by a different user from the debtor that has demanded the cancellation of the engine start disability, that is, determines that the vehicle 4 is used for the unintended purpose, and controls the immobilizer 42, to disable the engine start of the vehicle 4 again. The ECU 41 may extract the feature quantity by performing a well-known feature quantity extraction process, for example, an extraction process allowing the extraction of a Haar-Like feature quantity, a HOG feature quantity, or a SIFT feature quantity, to a still image corresponding to the still image data or a moving image corresponding to the moving image data. Naturally, the ECU 41 may extract the feature quantity using an after-learning model for which machine learning such as deep learning has been performed, that receives the still image data or the moving image data, and that outputs the feature quantity of the face of the person.

(3) For example, the ECU 41 determines whether the difference between the weight result (weight information) that is detected by the weight sensor 47 and that indicates the weight of a user that sits in the seat and weight information about a predetermined person that is recorded in the memory 40 is a predetermined value or more. The predetermined person includes the debtor linked with the vehicle 4, debtor's family members, previously registered users, and the like. For example, in the case where the difference between the weight result that is detected by the weight sensor 47 and that indicates the weight of the user that sits in the seat and the weight information that is recorded in the memory 40 and that is information about the debtor linked with the vehicle 4 is 5 kg or more, the ECU 41 determines that the vehicle 4 is used by a different user from the debtor that has demanded the cancellation of the engine start disability, that is, determines that the vehicle 4 is used for the unintended purpose, and controls the immobilizer 42, to disable the engine start of the vehicle 4 again.

(4) For example, the ECU 41 extracts a text and an architectural structure that are included in still image data or moving image data about the exterior of the vehicle 4 that is picked up by the image pickup device 45, and based on at least one of the extraction result and a predetermined destination included in the use purpose information, the ECU 41 determines whether the vehicle 4 is moving to the destination. The predetermined destination is destination information input by the debtor, workplace information about the debtor, or the like. In this case, the ECU 41 extracts the text or architectural structure that is included in the still image data or the moving image data, using an after-learning model for which machine learning such as deep learning has been previously performed, that receives the still image data or the moving image data, and that outputs the name of the architectural structure or the text. Then, in the case where the ECU 41 determines that the vehicle 4 is not moving to the destination, the ECU 41 determines that the vehicle 4 is not going toward the destination demanded by the debtor, that is, determines that the vehicle 4 is used for the unintended purpose, and controls the immobilizer 42, to disable the engine start of the vehicle 4. In this case, the ECU 41 may give warning on the display device 50 for a predetermined time, for example, for about five minutes, before disabling the engine start of the vehicle 4 again, and then, may control the immobilizer 42, to disable the engine start of the vehicle 4 again. Naturally, in the case where the vehicle 4 moves toward the destination after the warning on the display device 50, the ECU 41 may stop the warning. The ECU 41 may determine whether the vehicle 4 is moving to the destination, based on the extraction result about the text and architectural structure extracted from the still image data or moving image data about the exterior of the vehicle 4 that is picked up by the image pickup device 45, the predetermined destination that is included in the use purpose information, and map information that includes feature quantities of at least a text and an architectural structure and that is recorded in the memory 40.

(5) For example, in the case where the vehicle 4 has arrived at the destination, the ECU 41 extracts a text or a facility that is included in still image data or moving image data about the exterior of the vehicle 4 that is picked up by the image pickup device 45, and based on the extraction result and a facility at the predetermined destination that is included in the use purpose information, the ECU 41 determines whether the vehicle 4 has entered the facility. In this case, the ECU 41 extracts the text or facility that is included in the still image data or the moving image data, using an after-learning model for which machine learning such as deep learning has been previously performed, that receives the still image data or the moving image data, and that outputs the name of the facility or the text. Then, in the case where the ECU 41 determines that the vehicle 4 is not in the facility, the ECU 41 determines that the vehicle 4 is not in the facility demanded by the debtor, that is, determines that the vehicle 4 is used for the unintended purpose, and controls the immobilizer 42, to disable the engine start of the vehicle 4 again. In this case, the ECU 41 may give warning on the display device 50 for a predetermined time, for example, for about five minutes, before disabling the engine start of the vehicle 4 again, and then, may control the immobilizer 42, to disable the engine start of the vehicle 4 again. Naturally, in the case where the vehicle 4 moves toward the interior of the facility after the warning on the display device 50, the ECU 41 may stop the warning. For example, in the case where the vehicle 4 has arrived at the destination, the ECU 41 may extract the text and a facility that are included in the still image data or moving image data about the exterior of the vehicle 4 that is picked up by the image pickup device 45, and based on the extraction result, a facility at the predetermined destination that is included in the use purpose information, and map information that includes feature quantities of at least a text and a facility and that is recorded in the memory 40, the ECU 41 may determine whether the vehicle 4 has entered the facility.

(6) for example, the ecu 41 determines whether the weight detected by the weight sensor 47 is a predetermined threshold or more, and in the case where the weight is the predetermined threshold or more, the ecu 41 determines that a burden having a weight other than a weight for the use purpose is loaded on the vehicle 4, that is, determines that the vehicle 4 is used for the unintended purpose, and controls the immobilizer 42, to disable the engine start of the vehicle 4 again. in this case, there is a possibility that the user of the vehicle 4 loads a burden having a weight that is expected by the creditor, and for the protection of the vehicle 4 that is the credit, the ecu 41 controls the immobilizer 42, to disable the engine start of the vehicle 4 again. thereby, the creditor can perform the protection of the vehicle 4 that is the credit.

(7) For example, based on the position information about the vehicle 4 and a predetermined destination that is demanded by the debtor and that is included in the use purpose information, the ECU 41 determines whether the vehicle 4 has moved in a direction away from the destination for a predetermined time. For example, in the case where the vehicle 4 has moved in the direction away from the destination for the predetermined time, the ECU 41 determines that the vehicle 4 is used for the unintended purpose, and controls the immobilizer 42, to disable the engine start of the vehicle 4 again. In this case, the ECU 41 can perform the protection of the vehicle 4 that is the credit, while preventing a false application by a malicious debtor.

(8) For example, the ECU 41 determines whether the time of the use of the vehicle 4 after the engine start disability of the vehicle 4 is cancelled has exceeded a predetermined use time included in the use purpose information, and in the case where the time of the use of the vehicle 4 has exceeded the predetermined use time, the ECU 41 determines that the vehicle 4 is used for the unintended purpose, and controls the immobilizer 42, to disable the engine start of the vehicle 4 again.

In this way, the ECU 41 determines whether the vehicle 4 is used for the unintended purpose, by performing one or more of the above (1) to (8). In the case where the ECU 41 determines that the vehicle 4 is used for the unintended purpose (step S608: Yes), the vehicle 4 transitions to step S609. On the other hand, in the case where the ECU 41 determines that the vehicle 4 is not used for the unintended purpose (step S608: No), the vehicle 4 transitions to step S610.

Subsequently, the ECU 41 controls the immobilizer 42, to disable the engine start (step S609). The ECU 41 disables the engine start again, by setting the flag such that the immobilizer 42 does not react even when the start button of the vehicle 4 is pushed down. After step S609, the vehicle 4 ends the process.

In step S610, the ECU 41 determines whether the elapsed time after the engine start disability is cancelled has exceeded a predetermined time. For example, the predetermined time is a use time for the vehicle 4 that is demanded in the user purpose information by the debtor. Naturally, the predetermined time may be a time resulting from multiplying the use time for the vehicle 4 that is demanded in the use purpose information by the debtor, by a coefficient. In the case where the ECU 41 determines that the elapsed time after the engine start disability is cancelled has exceeded the predetermined time (step S610: Yes), the vehicle 4 transitions to step S609. On the other hand, in the case where the ECU 41 determines that the elapsed time after the engine start disability is cancelled has not exceeded the predetermined time (step S610: No), the vehicle 4 returns to step S606.

In the embodiment 2 described above, similarly to the above embodiment 1, it is possible to perform the protection of the credit, to achieve the credit collection, and to flexibly use the vehicle.

### Other Embodiments

Additional effects and modifications can be easily derived by a person skilled in the art. Consequently, a wider range of aspects of the present disclosure are not limited to the above expressed and described particular details and representative embodiments. Accordingly, various alterations are possible without departing from the spirit or scope of the inclusive concept of the present disclosure that is defined by the attached claims and equivalents thereof,

For example, in the embodiments 1 and 2, the description has been made as premises for the credit collection server 1 or the vehicle 4, but the credit management server 2 itself or the vehicle information server 3 itself may have the function of the control unit 11 or the ECU 41. In this case, the credit management server 2 or the vehicle information server 3 may have the functions of the control unit 11 and vehicle history DB 12 of the credit collection server 1. Further, in the vehicle control devices according to the embodiments 1 and 2, some processes in the credit collection server 1 and the vehicle information server 3 may be performed by the vehicle 4.

Further, in the embodiments of the present disclosure, the credit collection server 1, the credit management server 2, and the vehicle information server 3 have been described as devices that are separate from each other, but the credit collection server 1, the credit management server 2, and the vehicle information server 3 may be constituted by one device, two devices, or four or more devices.

What is claimed is:

1. A vehicle control device comprising a processor configured to:
perform a control to disable engine start of an object vehicle in response to receiving a first signal from a management server configured to manage a credit for the object vehicle, the first signal indicating that payment for the object vehicle has not been properly performed;
acquire use purpose information relevant to a purpose of use of the object vehicle;
determine whether the object vehicle is used for an intended purpose, based on the use purpose information;
perform a control to cancel the disability of the engine start of the object vehicle, when the processor determines that the object vehicle is used for the intended purpose;
acquire use situation information relevant to a situation of use of the object vehicle;
determine whether the object vehicle is used for an unintended purpose, based on the use situation information and the use purpose information; and
perform a control to disable the engine start of the object vehicle again, when the processor determines that the object vehicle is used for the unintended purpose.

2. A vehicle control device comprising a processor configured to:
perform a control to disable engine start of an object vehicle in response to receiving a first signal from a credit management server configured to manage a credit for the object vehicle, the first signal indicating that payment of a debt for the object vehicle has not been properly performed;
acquire use purpose information relevant to a purpose of use of the object vehicle;
determine whether the object vehicle is used for an intended purpose, based on the use purpose information;
perform a control to cancel the disability of the engine start of the object vehicle, when the processor determines that the object vehicle is used for the intended purpose;
acquire use situation information relevant to a situation of use of the object vehicle;
determine whether the object vehicle is used for an unintended purpose, based on the use situation information and the use purpose information; and
perform a control to disable the engine start of the object vehicle again, when the processor determines that the object vehicle is used for the unintended purpose.

3. A vehicle control device comprising a processor configured to:
disable engine start of an object vehicle when a first signal is received, the first signal indicating that payment of a debt for the object vehicle has not been properly performed;
acquire use purpose information relevant to a purpose of use of the object vehicle;
determine whether the object vehicle is used for an intended purpose, based on the use purpose information;
cancel the disability of the engine start of the object vehicle when the processor determines that the object vehicle is used for the intended purpose;
acquire use situation information relevant to a situation of use of the object vehicle;
determine whether the object vehicle is used for an unintended purpose, based on the use situation information and the use purpose information; and
disable the engine start of the object vehicle again, when the processor determines that the object vehicle is used for the unintended purpose.

4. The vehicle control device according to claim 3, wherein the processor is configured to:
disable the engine start of the object vehicle by outputting a disabling signal to an immobilizer included in the object vehicle, when the first signal is received, the disabling signal being a signal for disabling the engine start of the object vehicle by remote control;
cancel the disability of the engine start of the object vehicle by outputting a cancelling signal to the immobilizer, when the processor determines that the object vehicle is used for the intended purpose, the cancelling signal being a signal for cancelling the disability of the engine start of the object vehicle by remote control; and
disable the engine start of the object vehicle again by outputting the disabling signal to the immobilizer, when the processor determines that the object vehicle is used for the unintended purpose.

5. The vehicle control device according to claim 3, wherein the processor is configured to cancel the disability of the engine start when a second signal is received, the second signal indicating that temporary use of the object vehicle based on the use purpose information is permitted.

6. The vehicle control device according to claim 4, wherein the processor is configured to:
acquire first identification information as the use situation information, the first identification information being information for identifying a terminal device that exists in the object vehicle, the first identification information being emitted by the terminal device, the first identification information being detected by a detection unit included in the object vehicle;
acquire second identification information from a memory included in the object vehicle, the second identification information being information for identifying a predetermined information processing terminal; and
determine that the object vehicle is used for the unintended purpose, when the first identification information and the second identification information do not coincide with each other.

7. The vehicle control device according to claim 4, wherein the processor is configured to:
acquire still image data or moving image data as the use situation information, the still image data or the moving image data being picked up by an image pickup device included in the object vehicle;
extract a first feature quantity indicating a feature of a face of a person that is included in the still image data or the moving image data;
acquire a second feature quantity from a memory included in the object vehicle, the second feature quantity indicating a feature of a predetermined face; and
determine that the object vehicle is used for the unintended purpose, when a coincidence degree between the first feature quantity and the second feature quantity is less than a predetermined value.

8. The vehicle control device according to claim 4, wherein the processor is configured to:
acquire a weight of a passenger in the object vehicle as the use situation information, the weight of the passenger being measured by a weight sensor included in the object vehicle;
acquire weight information about a predetermined person from a memory included in the object vehicle; and
determine that the object vehicle is used for the unintended purpose, when a difference between the acquired weight and the weight information is a predetermined value or more.

9. The vehicle control device according to claim 4, wherein:
the use purpose information includes a predetermined destination; and
the processor is configured to:
acquire still image data or moving image data as the use situation information, the still image data or the moving image data being picked up by an image pickup device included in the object vehicle;
extract, as an extraction result, one of a text and an architectural structure that are included in a still image corresponding to the still image data or a moving image corresponding to the moving image data;
determine whether the object vehicle is moving to the destination, based on at least one of the extraction result and the destination included in the use purpose information; and
determine that the object vehicle is used for the unintended purpose, when the processor determines that the object vehicle is not moving to the destination.

10. The vehicle control device according to claim 4, wherein:
the use purpose information includes a facility at a predetermined destination; and
the processor is configured to:
acquire still image data or moving image data as the use situation information, the still image data or the moving image data being picked up by an image pickup device included in the object vehicle;
extract, as an extraction result, one of a facility and a text that are included in a still image corresponding to the still image data or a moving image corresponding to the moving image data;
determine whether the object vehicle has entered the facility, based on the extraction result and the facility at the destination, when the object vehicle has arrived at the destination; and
determine that the object vehicle is used for the unintended purpose, when the processor determines that the object vehicle has not entered the facility.

11. The vehicle control device according to claim 4, wherein the processor is configured to:
acquire a weight measured by a weight sensor included in the object vehicle, as the use situation information; and
determine that the object vehicle is used for the unintended purpose, when the weight is a predetermined threshold or more.

12. The vehicle control device according to claim 4, wherein:
the use purpose information includes a predetermined destination; and
the processor is configured to:
acquire position information about the object vehicle as the use situation information, the position information being measured by a positioning sensor included in the object vehicle; and
determine that the object vehicle is used for the unintended purpose, when the object vehicle has moved for a predetermined time in a direction away from the destination, based on the position information and the destination included in the use purpose information.

13. The vehicle control device according to claim 4, wherein:
the use purpose information includes a predetermined use time; and
the processor is configured to determine that the object vehicle is used for the unintended purpose, when a time of use of the object vehicle has exceeded the predetermined use time.
